(19) United States
(12) Patent Application Publication
(10) Pub. No.: US 2019/0078339 A1
(43) Pub. Date: Mar. 14, 2019

(54) ADJUSTABLE ROOFING SCAFFOLD SYSTEM AND METHOD OF USE

(71) Applicant: Morris Robinson, Chicago, IL (US)

(72) Inventor: Morris Robinson, Chicago, IL (US)

(21) Appl. No.: 15/699,742

(22) Filed: Sep. 8, 2017

(51) Int. Cl. E04G 3/22; E04G 5/04; A62B 35/00

(52) U.S. Cl. CPC E04G 3/22; A62B 35/0068; E04G 5/041

(57) ABSTRACT

An adjustable roofing scaffold system comprising a plurality of scaffold members with attached platform support structures, a hooking feature, and at least one scaffold platform configured to be attached to the plurality of scaffold members. Wheels may also be attached to each scaffold member to facilitate movement and adjustment of the system. The scaffold members may also be configured to form ladder-like structures with coupled guiderails for a user. The system may be assembled by coupling a hooking feature to the scaffold member, the scaffold member positioned upon a roof, the platform support structures attached to the scaffold member, and the platform members attached between scaffold members to complete the system. The system may be assembled, adjusted, and disassembled in various combinations, with each component capable of being removed from the rest.

### BACKGROUND OF THE INVENTION

The present invention relates to roof construction and repair. Specifically, this invention relates to a roof scaffolding system, adjustable scaffold members, and a method of use.

Modern roofing techniques require a cornucopia of tasks that must be completed before actual work on the roof itself can begin. These tasks may range from transporting heavy machinery and scaffolding equipment to a particular job site to the strenuous task of constructing said scaffolding. Many times the first day or two of work for a contractor consists of nothing but preparatory tasks in advance of substantive roof construction. This can lead to inordinate costs to a client when accounting for labor hours. It can also lead to gridlock for a roofing business, unable to service multiple clients in a short time without more added costs.

Current scaffolding techniques and apparatuses can also be damaging to roofs as well. Many times, in order to secure scaffolding systems to a roof, the platform supports must be nailed into the roof itself, leading to more work in order to fix the damages, or to a lack of repair at all.

Typical scaffolding systems also have a limited area of coverage, usually around 40 square feet after assembly and anchoring. This limited work area tends to warrant reassembly of the scaffolding as necessary in order to achieve the coverage needed to complete a particular job. This constant requirement of tearing down and reassembling the scaffolding leads to further costs for both the contractor and the client.

The present invention seeks to provide solutions to the aforementioned issues surrounding the use of typical roofing scaffold systems by providing an adjustable roofing scaffold system that enables a roof worker to quickly and efficiently tailor the scaffolding to the current needs of the construction job, without first needing to disassemble the entire system.

### SUMMARY OF THE INVENTION

The present invention is directed to an adjustable roofing scaffold member, an adjustable scaffolding system and a method of use. The adjustable roofing scaffold system comprises a plurality of scaffold members and at least one scaffold platform configured to be removably attached to the plurality of scaffold members.

In one embodiment, the scaffolding system comprises a plurality of scaffold members, each capable of being placed on a surface of a roof. Each of the plurality of scaffold members comprises a hooking feature coupled to an end. At least one side of each of the plurality of scaffold members further comprises a plurality of attachment points. At least one platform support structure configured to couple a platform member to the scaffold member. The at least one platform support structure may be coupled to the scaffold member at intervals suitable for the typical placement of scaffolding platforms.

In some embodiments, each of the plurality of scaffold members may further comprise wheels coupled to a side, configured to facilitate movement of each scaffold member during the adjustment of the system.

In some embodiments, each scaffold member of the plurality of scaffold members further comprises a series of attachment features disposed at an interval along a side of each member, configured to couple a personal fall arrest system worn by a user.

In another embodiment, at least one of the plurality of scaffold members may comprise at least one rail member. The rail member may be coupled to both ends of each scaffold member and extend the length of the scaffold member. The rail member is configured to aid the stability of a user both while adjusting the scaffold member and when utilizing the scaffold system.

In another embodiment, the scaffold members may further comprise step features coupled to a side of the scaffold member at suitable intervals, configured to perform a ladder-like function while the scaffold member is placed upon a roof. In some embodiments, the rail member may be coupled to the step features to form a railing structure. The step features may also comprise wheels coupled thereto, further facilitating adjustment of the attached scaffold member.

Another aspect of the invention comprises a method for assembling and adjusting the adjustable scaffolding system. The method for assembly of the system comprises coupling at least one platform support structure to each of the plurality of scaffold members, at an initially suitable frequency along each scaffold member. The hooking feature is then coupled to an end of each scaffold member of the plurality of scaffold members. Each of the plurality of scaffold members with attached platform support structure and hooking feature is then placed partially onto a roof. Each of the scaffold members are then positioned such that the hooking feature is extended over the peak of the roof, securing the scaffold member to the roof. At least one scaffold platform member is then coupled to the corresponding platform support structures of each scaffold member, thereby coupling each scaffold member to another and completing the scaffold system. To adjust the scaffolding system, the platform members may be removed and repositioned, along with the platform support structures, thereby tailoring a layout that suits any needs of the user.

The methods, systems, and apparatuses are set forth in part in the description which follows, and in part will be obvious from the description, or can be learned by the practice of the methods, apparatuses, and systems. The advantages of the methods, apparatuses, and systems will be realized and attained by means of elements and combinations particularly pointed out in the appended claims. It is to be understood that both the foregoing general description and the following detailed description are exemplary and explanatory only and are not restrictive of the methods, apparatuses, and systems, as claimed. More details concerning these embodiments, and others, are further described in the following figures and detailed description set forth herein below.

### BRIEF DESCRIPTION OF THE DRAWINGS

In the accompanying figures, like elements are identified by like reference numerals among the several preferred embodiments of the present invention.

FIG. 1 is a perspective view of the adjustable roofing scaffold system.

FIG. 2 is a perspective view of a scaffold member and platform support structures.

FIG. 3 is a perspective view of a platform support structure.

FIG. 4 is a perspective view of the hooking feature.

FIG. 5 is a perspective view of the plurality of wheels attached to the scaffold member.

FIG. 6 is a perspective view of a platform member coupled to a platform support structure.

FIG. 7 is a perspective view of a scaffold member with attached step features and rail members.

FIG. 8 is a profile view of the adjustable roofing scaffold system.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known customary practice within the art to which the invention pertains.

### DETAILED DESCRIPTION OF THE PREFERRED EMBODIMENTS

The foregoing and other features and advantages of the invention will become more apparent from the following detailed description of exemplary embodiments, read in conjunction with the accompanying drawings. The detailed description and drawings are merely illustrative of the invention rather than limiting, the scope of the invention being defined by the appended claims and equivalents thereof.

A majority of components of the present invention are intended to be adjustable and capable of disassembly with little effort on behalf of a user. As such, those of ordinary skill in the art would appreciate that use of the term “coupled” in any form in the present application, is defined as “removably coupled,” unless otherwise specified.

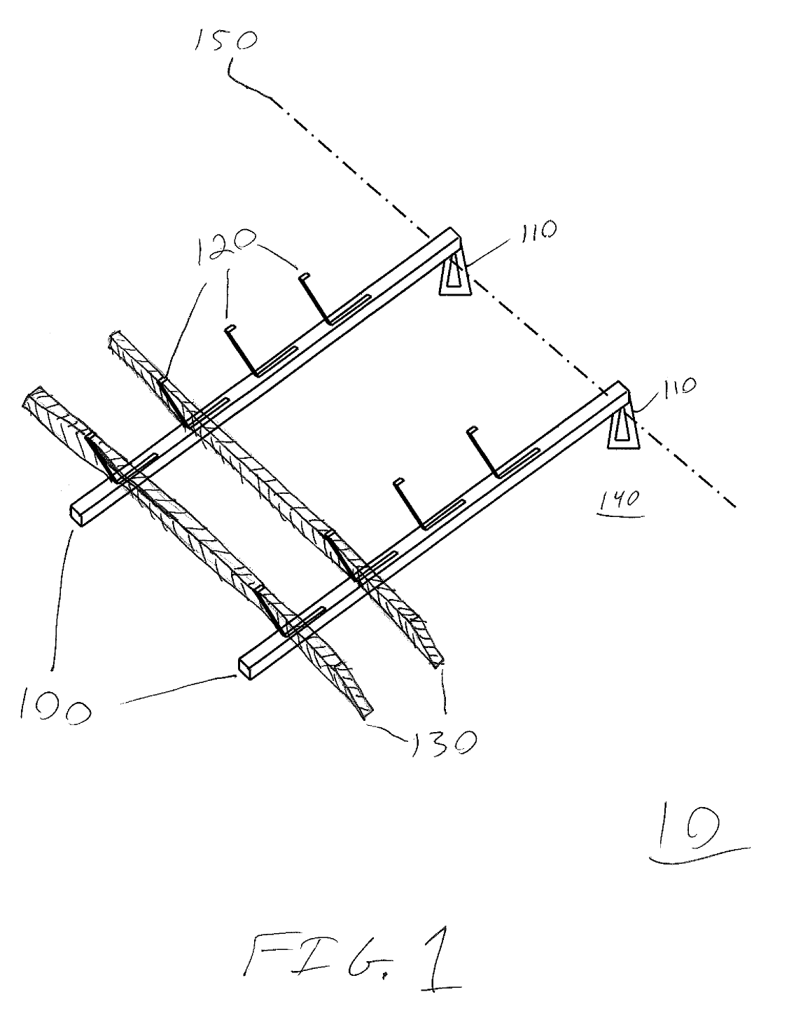

The adjustable roofing scaffold system 10 is represented in FIG. 1, comprising a plurality of scaffold members 100, each further comprising a plurality of attachment points disposed along at least one side of the scaffold member 100, a hooking feature 110 configured to couple a surface of a roof 140, and at least one platform support structure 120 coupled thereto and further coupled to at least one platform member 130, connecting each scaffold member 100 to another. The system 10 is configured to adjustably mount a roof surface 140 by placing the scaffold member 100 upon the roof surface 130, abutting the scaffold member 100 against the roof peak 150 using the hooking feature 110, coupling the at least one platform support structure 120 to the scaffold member 100, and linking the system 10 together by coupling a platform member 130 to another corresponding platform support structure 120 on each of the plurality of scaffold member 100. A person of ordinary skill in the art will understand that the various components of the scaffold system 10 may be manufactured from any industry-standard material, including but not limited to, iron, iron alloys, wood, and thermoplastic polymers.

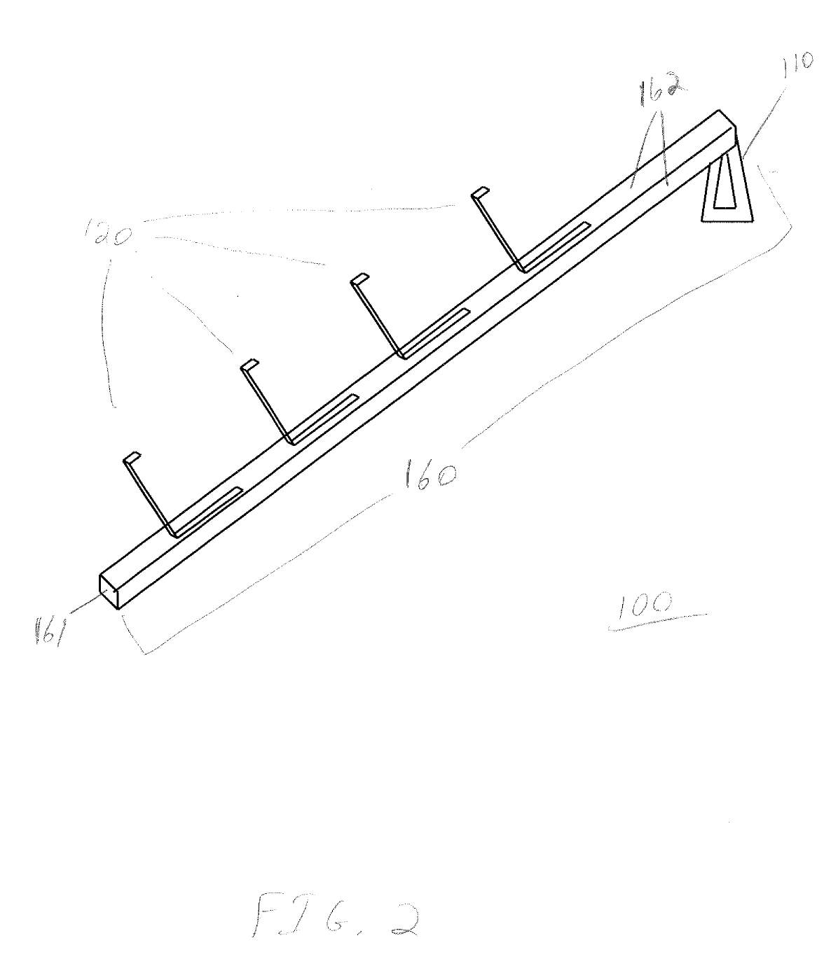

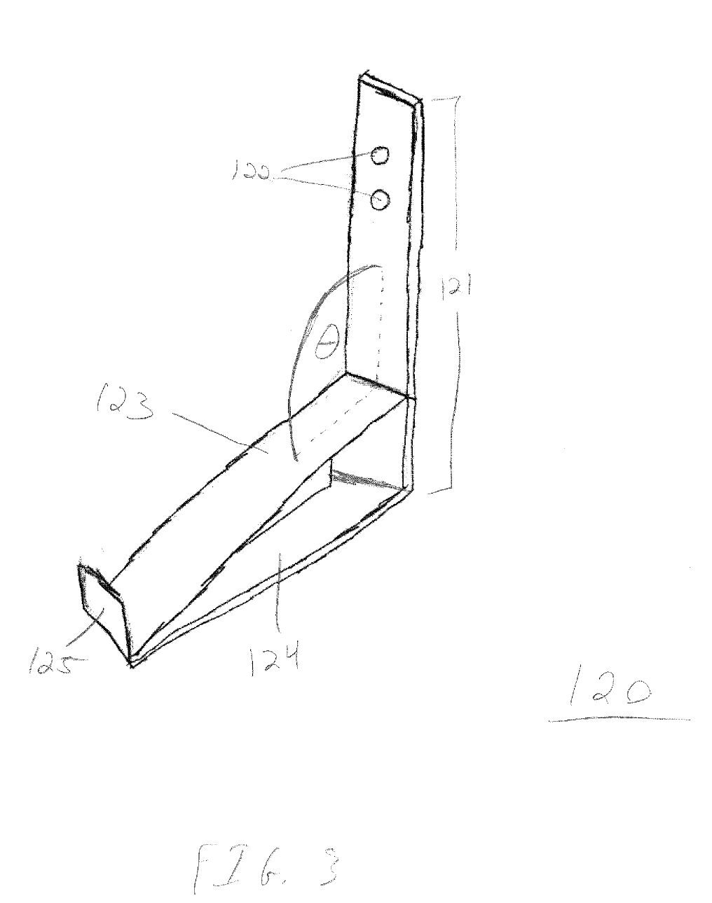

FIG. 2 illustrates a perspective view of a scaffold member 100 comprising a stick member 160 defined by a top surface (not shown), a bottom surface 161 and a plurality of sidewalls 162, with a plurality of attachment points (not shown) disposed along at least one sidewall 162 configured to couple at least one platform support structure 120, and a hooking feature 110 coupled to the top surface. The platform support structure 120, as shown in FIG. 3, comprises an anchoring portion 121 with an attachment mechanism 122 disposed thereupon, configured to couple a scaffold member 100. The platform support structure 120 further comprises a cradle portion 123 extending from an end of the anchoring portion 122, forming an angle θ with the anchoring portion 121 configured such that a platform member 130 may be coupled to the cradle portion 123 of the platform support structure 120 and form a level surface for a user.

In another embodiment, the platform support structure 120 may comprise a stabilizing portion 124, extending from an end of the anchoring portion 121 and connecting to a second end of the cradle portion 123, configured to facilitate rigidity and stability between the anchoring and cradle portions 121,123. A retention member 125 extends from where the cradle and stabilizing portions 123,124 meet, configured to retain a platform member 130 to the platform support structure 120. A first end of the cradle portion 123 is attached to the anchoring portion 121 at a point such that a platform member 130 may be coupled to the cradle portion 123 and retention member 125 of the platform support structure 120 to form a level surface for a user.

A person of ordinary skill in the art would appreciate that the at least one platform support structure 120 may be manufactured from similar materials as the plurality of scaffold members 100, including but not limited to iron, iron alloys, wood, or thermoplastic polymers. It will also be appreciated by one of ordinary skill in the art that the platform support structure 120 may comprise cradle and stabilizing portions 123, 124 and a retention member 125 dimensioned to fit various sizes of platform members 130. The platform support structure 120 may also comprise cradle and stabilizing portions 123,124 and retention members 125 configured to extend and retract along a longitudinal axis, allowing for adjustment of a platform support structure 120 to a dimension sufficient to couple a particular platform member 130. A mechanism configured to allow extension and retraction of the platform support structure 120 may comprise, but is not limited to, telescoping members, friction fit members, or slotted members.

In other embodiments of the invention, at least one of the plurality of attachment points may be coupled to a personal fall arrest system (not shown), as defined by the Occupational Safety and Health Administration (OSHA) in 29 CFR 1926.502(d) and incorporated by reference. The personal fall arrest system may be coupled to the scaffold member 100 and also coupled to a user and configured to secure a user to the scaffold member 100 and roof 140 in the event of an accident.

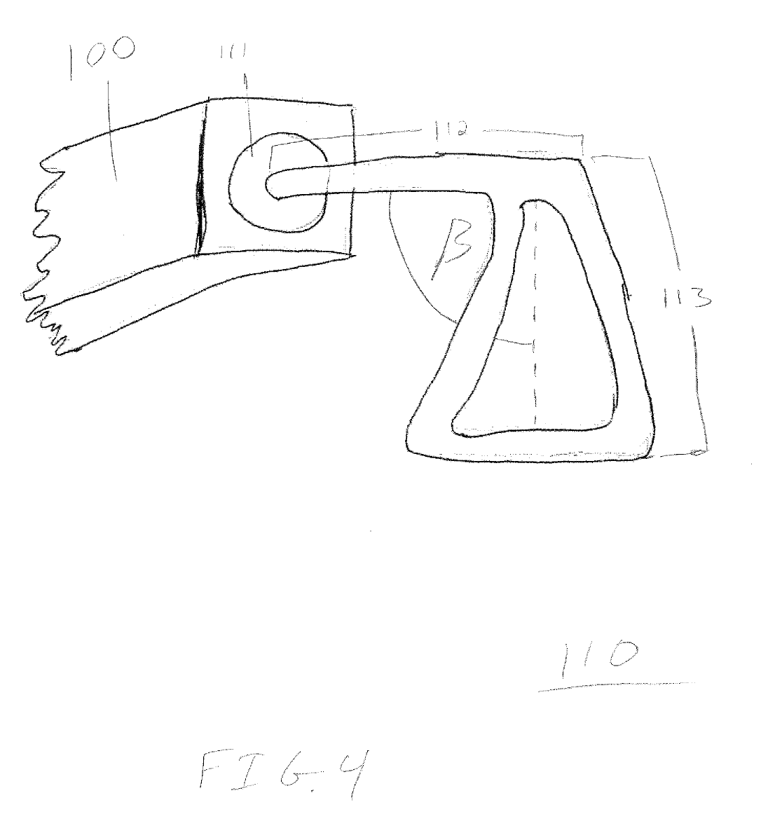

FIG. 4 illustrates a hooking feature 110 coupled to an end of the scaffold member 100, configured to retain the scaffold member 100 and scaffold system 10 against the surface of a roof 140. The hooking feature 110 comprises an attachment feature 111 at an end, configured to couple the hooking feature to an end of the scaffold member 100. A person of ordinary skill in the art will appreciate that the attachment feature 111 may include but is not limited to, a threaded surface, bracket, or other industry standard linking mechanism. The hooking feature 110 further comprises an elongated portion 112 that extends from the attachment feature 111 a distance suitable to couple a peak of a roof. The hooking feature 110 further comprises a bracing portion 113 extending from an end of the elongated portion 112 and forming an angle β with the profile of the scaffold member 100. The angle β formed between the bracing portion 113 of the hooking feature 110 and the scaffold member 100 is configured to allow the scaffold member 100 to conform to the surface of a roof 140 while still being coupled thereto and providing stability to the system 10.

In some embodiments, the hooking feature 110 may further comprise a bracing portion 113 configured to facilitate a greater surface area of the hooking feature 110 and enhance surface grip. The hooking feature 110 may also comprise an enlarged looped profile, including but not limited to, a circle, teardrop, or polygonal shape. A padding feature may also be disposed upon the surface of the hooking feature 110, configured to enhance the surface grip of the hooking feature 110 while coupled to the surface of a roof 140.

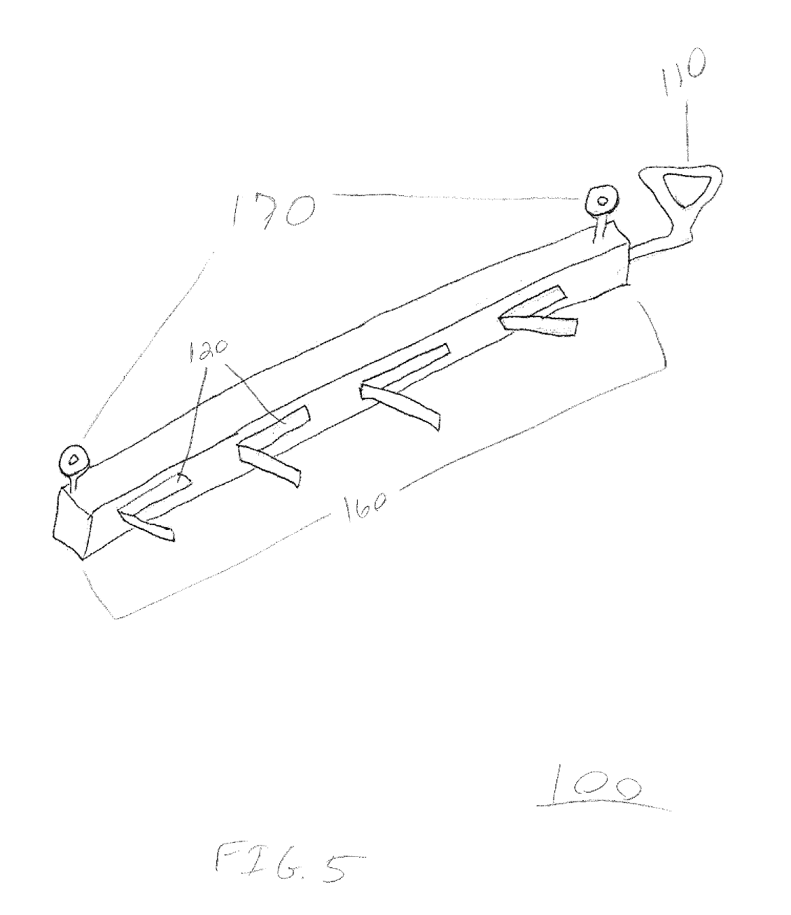

In some embodiments, the scaffold member 100 may further comprise at least one wheel 170, shown in FIG. 5, coupled to a side of the stick member 160, configured to facilitate movement of the scaffold member 100 during assembly and adjustment of the system 10 while coupled to the surface of a roof 140. The at least one wheel 170 may be coupled to a side of the stick member such that the wheel 170 is in constant contact with the surface of the roof 140 while the system 10 is in use. The at least one wheel 170 may be coupled to a side such that contact between the wheel 170 and the surface of the roof 140 occurs only during assembly, adjustment, and disassembly of the system 10.

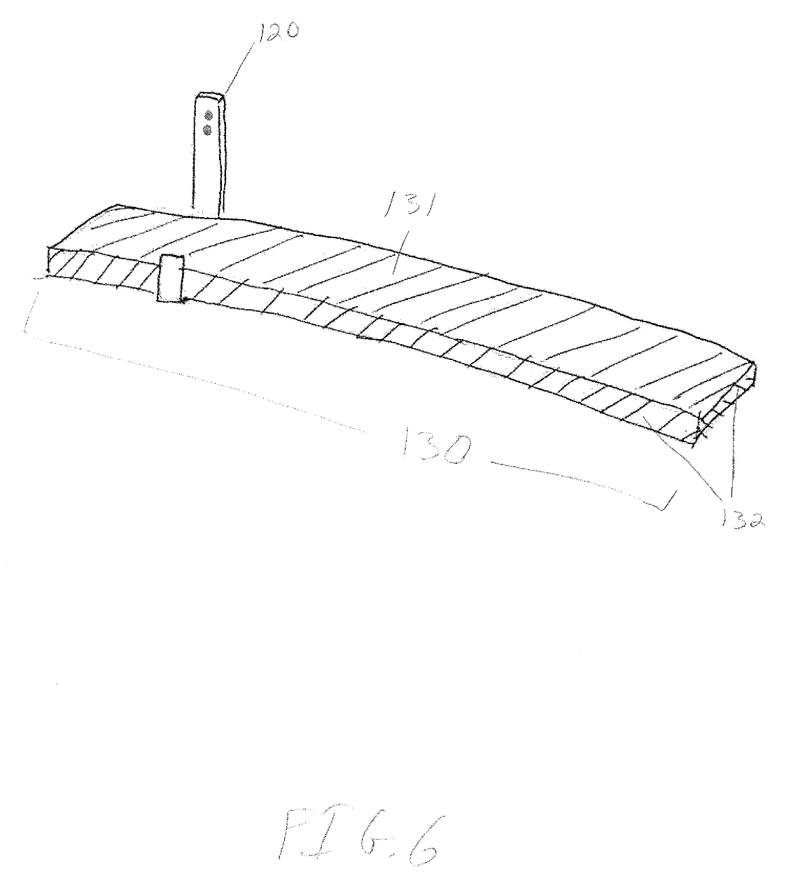

The at least one platform member 130, as shown in FIG. 6, comprise a top surface 131, bottom surface (not shown), and a plurality of sidewalls 132, configured to couple at least one platform support structure 120 attached to the scaffold member 100. The platform member 130 may also comprise a groove disposed upon the top surface 131 or bottom surface, configured to facilitate coupling of the platform member 130 to the platform support member 120. In some embodiments the top surface 131, bottom surface, and sidewalls 132 of the platform member 130 may comprise surface features configured to enhance surface grip between both the platform member 130 and the support member 120, as well as between the platform member 130 and a user. The surface features may include a rubberized coating or further configured with a pattern disposed therein and the pattern may include, but is not limited to, grooved or studded patterns.

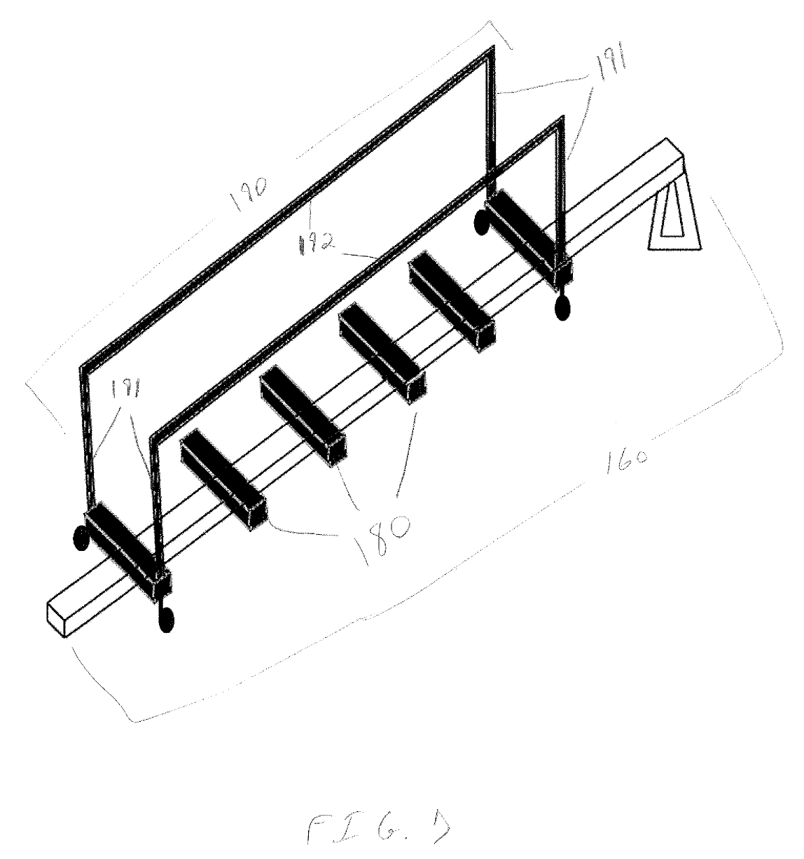

In other embodiments of the invention, as shown in FIG. 7, the scaffold member 100 may comprise a plurality of step features 180 disposed at an interval along a side of the stick member 160, configured to allow a user to climb the scaffold member 100 in a ladder-like fashion. The plurality of step members 180 may be composed of materials similar to the rest of the system 10, and may be coupled to the scaffold member 100 by an attachment mechanism that is the same or similar to the attachment mechanism between the platform support structure 120 and scaffold member 100.

In some embodiments, the scaffold member 100 may also comprise at least one rail member 190 coupled to the plurality of step features 180, configured to stabilize a user while traversing the step features 180. The rail members 190 may comprise at least one support structure 191 coupled to the step features 180. The support structure 191 is coupled to and configured to support at least one guide rail 192, configured to be gripped by and guide a user during ascent or descent of the plurality of step features 180.

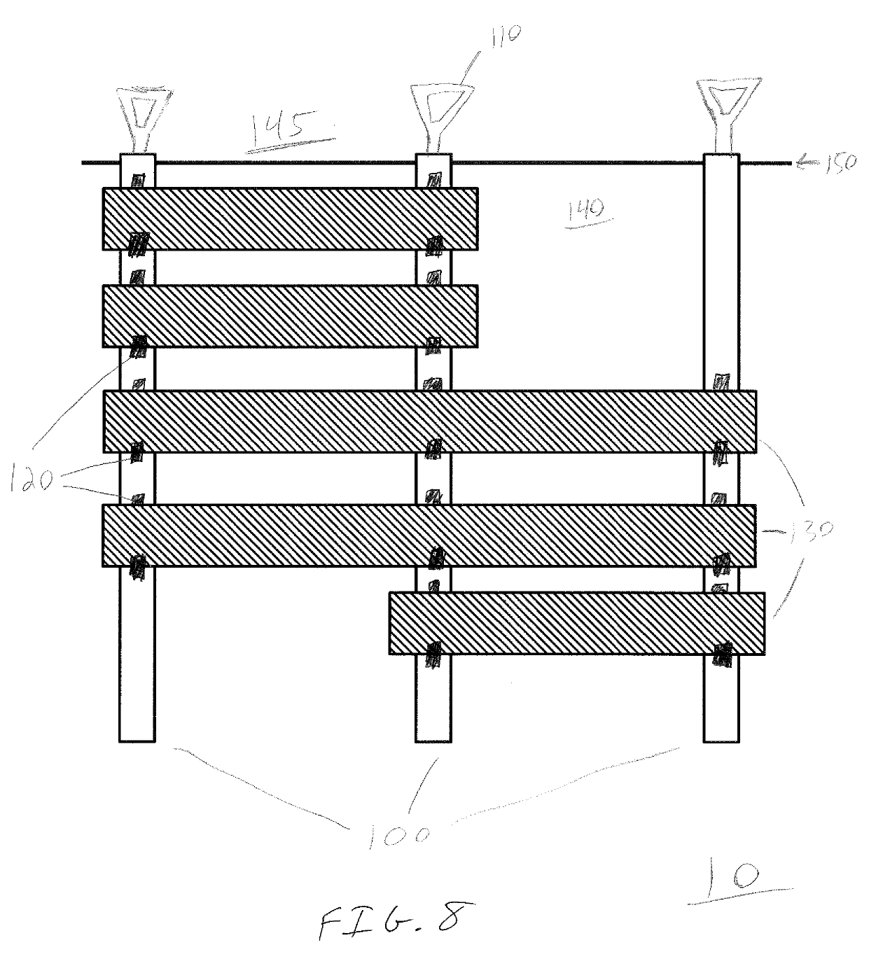

The method for using the adjustable roof scaffolding system 10 comprises coupling at least one platform support structure 120 to each of the plurality of scaffold members 100, at an initially suitable frequency along each scaffold member 100. The hooking feature 110 is then coupled to an end of each scaffold member 100. Each scaffold member of the plurality of scaffold members 100 with at least one attached platform support structure 120 and hooking feature 110 is then placed upon the surface of the roof 140. Each of the plurality of scaffold members 100 are then positioned such that the hooking feature 110 extends over a peak of the roof 150, abutting an adjacent slope of the roof 145, thereby securing each of the scaffold members 100 to the surface of the roof 140. At least one platform member 100 is then coupled to the corresponding platform support structure 120 of each scaffold member 100, thereby coupling each scaffold member 100 to another and completing the scaffold system 10. The coupling of a platform member 130 is then repeated until the system 10 comprises at least one platform member 130 configured in a pattern suitable for the purposes of the user, as shown in FIG. 8.

To adjust the scaffold system 10, the at least one platform member 130 is decoupled from the at least one platform support structure 120. The platform support structure or structures 120 are then decoupled from each scaffold member of the plurality of scaffold members 100. Each platform member of the plurality of scaffold members 100 are then decoupled from the surface of the roof 140 by raising the scaffold member 100 over the peak of the roof 150 until the hooking feature 110 is no longer abutting the opposite surface of the roof 145. The scaffold members 100 are each then placed in a new position along the surface of the roof 140, the hooking features 110 reengaged with the peak 150 and opposite surface of the roof 145. The at least one platform support structure or structures 120 are then recoupled to the scaffold member 100 in positions to suit the needs of the user. Each platform member 130 is then recoupled to the corresponding platform support structures 120 to relink the system 10 together. One of ordinary skill in the art would understand that not all the above described steps need be performed to adjust the system 10, and that the steps may be performed in such an order to provide sufficient customization of the system 10 to configure a coverage area suitable for the needs of the user.

Disassembly of the system 10 may be performed by first decoupling each platform member 130 from each of the platform support structures 120. At least one of the platform support structure 120 may then be decoupled from the plurality of scaffold members 100. Next, the plurality of scaffold members 100 may be decoupled from the surface of the roof 140 by raising the scaffold member 100 over the peak of the roof 150 until the hooking feature 110 is no longer abutting the opposite surface of the roof 145. The scaffold members 100 may then be rotated until the hooking feature 110 is disposed along a horizontal axis that is parallel to and clears of the peak of the roof 150. The scaffold members 100 are then further removed from the surface of the roof 140 by either utilizing the at least one wheel (not shown) disposed along a side of the scaffold member 100, or by sliding the scaffold member 100 off the surface of the roof 140. Once removed from the surface of the roof 140, the hooking feature 110 may be decoupled from the stick member 160 of the scaffold member 100.

A person of ordinary skill in the art will appreciate that the above described steps for disassembly of the system 10 may be performed in any order deemed necessary by the user for a given situation or project. The system 10 may be removed from the surface of the roof 140 as one piece and then dissembled, or each component disassembled and then removed from the surface of the roof 140.

Those of ordinary skill in the art will understand and appreciate the foregoing description of the invention has been made with reference to certain exemplary embodiments of the invention, which describe an adjustable roof scaffold system and method of use. Those of skill in the art will understand that obvious variations in construction, material, dimensions or properties may be made without departing from the scope of the invention which is intended to be limited only by the claims appended hereto.

What is claimed is:

1.) An adjustable roofing scaffold system, comprising:
a. a plurality of scaffold members each having a plurality of attachment points disposed upon at least one surface thereof;
b. at least one scaffold member of the plurality of scaffold members further having a hooking feature coupled to or extending from an end of the at least one scaffold member, the hooking member comprising an elongated portion and a bracing portion and configured to abut and couple a surface of a roof;
c. at least one platform support structure coupled to an attachment point of the plurality of attachment points of each scaffold member of the plurality of scaffold members, the at least one platform support structure having an anchoring portion configured to couple the scaffold member and a cradle portion configured to couple and retain at least one platform member to the platform support structure ; and
at least one platform member coupled to the at least one platform support member of at least two successive scaffold members of the plurality of scaffold members;

2.) The adjustable roofing scaffold system of claim 1, wherein the at least one platform support structure further comprises a stabilizing portion coupled to the anchoring and cradle portions and configured to facilitate rigidity and stability between the anchoring and cradle portions of the platform support structure.

3.) The adjustable roofing scaffold system of claim 2, wherein the cradle and stabilizing portions are further configured to extend and retract to accommodate various sizes of platform members.

4.) The adjustable roofing scaffold system of claim 1, wherein at least one of the plurality of attachment points is configured to support and couple to a personal fall arrest system.

5.) The adjustable roofing scaffold system of claim 1, wherein the bracing portion of the hooking feature further comprises an enlarged, looped profile with surface features disposed thereupon and configured to enhance surface grip between the hooking feature and the surface of a roof.

6.) The adjustable roofing scaffold system of claim 1, wherein at least one scaffold member of the plurality of scaffold members further comprises at least one wheel disposed along a surface, the at least one wheel configured to allow movement of the scaffold member along the surface of a roof.

7.) The adjustable roofing scaffold system of claim 1, wherein the at least one platform member further comprises a coating disposed upon at least one surface thereof and configured to enhance surface grip between both the platform member and platform support structure and the platform member and a user.

8.) The adjustable roofing scaffold system of claim 1, wherein at least one scaffold member of the plurality of scaffold members comprises a plurality of step features coupled thereto and configured to form a ladder structure along a side of the scaffold member.

9.) The adjustable roofing scaffold system of claim 8, wherein the plurality of step features further comprises at least one rail member coupled thereto forming a guiderail configured to enhance stability of a user while maneuvering the step features.

10.) A method for using an adjustable roofing scaffold system, comprising the steps of:
a. coupling a hooking feature to an end of each scaffold member of a plurality of scaffold members;
b. positioning each scaffold member of the plurality of scaffold members upon a surface of a roof such that the hooking feature of each extends over a peak of the roof and abuts an opposite surface of the roof, thereby securing each scaffold member to the surface of the roof;
c. coupling at least one platform support structure to each scaffold member;
d. coupling a first end of at least one platform member to the platform support structure of a first scaffold member; and
e. coupling a second end of the at least one platform member to the platform support structure of a second scaffold member.
